(19) United States
(12) Patent Application Publication
(10) Pub. No.: US 2007/0175967 A1
(43) Pub. Date: Aug. 2, 2007

(54) High integrity welding and repair of metal components

(76) Inventors: Narasimha-Rao Venkata Bangaru, Pittstown, NJ (US); Jayoung Koo, Somerset, NJ (US); Glen A. Vaughn, Ozark, MO (US); Raghavan Ayer, Bernards Township, NJ (US); Douglas P. Fairchild, Sugar Land, TX (US)

Correspondence Address: ExxonMobil Research and Engineering Company, P.O. Box 900, Annandale, NJ, 08801-0900, US

(21) Appl. No.: 11/639,533

(22) Filed: Dec. 15, 2006

Related U.S. Application Data
(60) Provisional application No. 60/763,101, filed on Jan. 27, 2006.

(51) Int. Cl. B23K 20/12

(52) U.S. Cl. 228/112.1

(57) ABSTRACT

A method for welding and repairing cracks in metal parts is provided by subjecting the metal parts to be welded to friction stir welding and the cracks to be repaired to friction stir processing under conditions sufficient to provide a weld joint or crack repair having a preselected property or set of properties based upon the intended use of the weldment.

This application claims the benefit of U.S. Provisional application 60/763,101 filed Jan. 27, 2006.

### FIELD OF THE INVENTION

The present invention relates generally to the field of friction stir welding and friction stir processing. More specifically, the invention pertains to welding and repairing metal parts, particularly but not exclusively, ferrous metal parts, to provide welded joints with specific distinguished properties such as strength, fatigue, toughness and the like.

### BACKGROUND OF THE INVENTION

For convenience, various welding terms used in this specification are defined in the Glossary of Terms below.

### GLOSSARY OF TERMS

HAZ: Heat-affected-zone.

Heat-affected-zone: Base metal that is adjacent to the weld fusion line and that was affected by the heat of welding.

Toughness: Resistance to fracture initiation.

Fatigue: Resistance to fracture under cyclic loading.

Strength: Ability to bear load without deformation.

FSW: Friction stir welding.

Friction Stir Welding: A solid state joining process for creating a welded joint between two work pieces in which the heat for joining the metal work pieces is generated by plunging a rotating pin of a tool between the work pieces.

FSP: Friction stir processing.

Friction stir processing: The method of processing and conditioning the surface of a structure by pressing a FSW tool against the surface without actually plunging a pin into the structure.

Weld joint: A welded joint including the fused or thermo-mechanically altered metal and the base metal in the “near vicinity” of, but beyond the fused metal. The portion of the base metal that is considered within the “near vicinity” of the fused metal varies depending on factors known to those in the welding art.

Weldment: An assembly of component parts joined by welding.

Weldability: The feasibility of welding a particular metal or alloy. A number of factors affect weldability including chemistry, surface finish, heat-treating tendencies and the like.

Carbon equivalent: A parameter used to define weldability of steels and expressed by the formula CE=C+Mn/6+(Cr+Mo+V)/5+(Ni+Cu)/15 where all units are in weight percent.

Hydrogen cracking: Cracking that occurs in the weld subsequent to welding.

TMAZ: Thermo-mechanically affected zone.

Thermo-mechanically affected zone: Region of the joint that has experienced both temperature cycling and plastic deformation.

TMAZ-HZ: The hardest region in a weldment.

### LONG-FELT NEED FOR THE INVENTION

The joining of metal parts such as pipes and tubes to form pipelines for oil, gas and geothermal wells and the like is largely performed by conventional arc welding. In such a process the larger the pipe diameter, or the thicker the wall of the pipe, the slower the welding becomes. For offshore pipelines, it is important that the welding be as economic as possible because of the substantial costs associated with the laybarge. Also, in welding pipes for offshore pipelines, there is the problem of bending stresses that results from the completed pipe hanging off the stem of the laybarge. In addition, conventional fusion welded joints suffer from other attributes which degrade the mechanical integrity of the joints. Examples of such attributes are tensile residual stress, hydrogen cracking, lack of fusion defects and low toughness. Thus there is a need for a new method both for rapidly joining steels and to achieve joints with superior performance.

In the case of high carbon content steels, such as casing steels that have a CE equal to or greater than 0.48, current welding practice requires preheating the work pieces to 100-400° C. and forming the weld with low hydrogen electrodes to minimize the formation of a hard HAZ which is susceptible to cracking. Because of the difficulties associated with such a welding technique, often high carbon steel work pieces are mechanically joined instead using various types of couplings.

Thus there is a need for a reliable method for rapidly welding high carbon steels which minimizes grain coarsening in the HAZ and weldment cracking.

As should be appreciated from the foregoing, conventional fusion welding is prone to crack initiation that originates typically in the HAZ. In the case of the petrochemical industry where thousands of miles of pipes are installed each year to transport gas, oil and fluids, the costs for repairs are significant. Hard and low toughness regions weldment, especially the HAZ, are also prone to develop cracks in service particularly when the welded component is used in sour service or other aggressive process environments. It is essential that these cracks are repaired before they grow to a critical dimension when they can propagate catastrophically.

Thus there is a need for a method for economically repairing weld joints. Indeed, there is a need for repairing weld joints and metal work pieces that can be performed in the absence of an open flame.

An object of the present invention is to provide a method for welding metal work pieces such that the weld joint has properties optimized for the intended use of the weldment.

Another object of the invention is to provide a method for welding high carbon steels in which grain coarseness in the HAZ is minimized.

Yet another object of the invention is to provide a more economical method for repairing cracks in metal work pieces.

### SUMMARY OF THE INVENTION

Broadly stated, the present invention provides a method for welding and for repairing metal parts, especially but not exclusively ferrous metal parts, by subjecting the faying surfaces of metal parts to be welded to FSW and the cracks to be repaired to FSP under conditions sufficient to provide a weld joint or crack repair having a preselected set of properties based on the intended use of the weldment.

In one embodiment of the invention the FSW tool rotational speed, load and travel speed are chosen to provide preselected properties of the weld joint or repair.

In another embodiment of the invention a metallic shim of preselected chemistry is interposed between the faying surfaces of the work pieces before FSW to tailor the weld properties. Typically, the property or set of properties will be selected from toughness, hardness, strength, fatigue, grain size and residual stress.

These and other embodiments of the invention will become apparent upon a reading of the detailed description of the invention which follows.

### BRIEF DESCRIPTION OF THE DRAWINGS

FIG. 1 is a schematic illustration of the method of joining two tubular work pieces by FSW.

FIG. 2 is a diagram showing the use of a metallic shim in joining two pipes according to an embodiment of the present invention.

FIG. 3 is cross section micrograph (a) of FSW butt welded L80 steel plates (Run 1, Table 1) and diamond pyramid microhardness (DPH, 100 gram load) profile across this weldment (b).

### DETAILED DESCRIPTION OF THE INVENTION

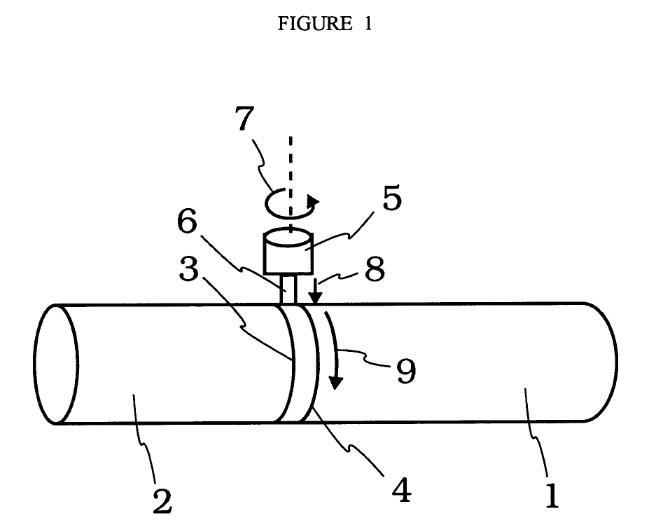

Referring to FIG. 1, there are shown two tubular work pieces 1 and 2 which are positioned so that their faying surfaces 3 and 4 are in contact with each other.

The work pieces, 1 and 2, are to be welded to one another along their faying surfaces 3 and 4.

As shown in FIG. 1, the FSW tool comprises a welding head 5 having a friction pin 6. The work pieces 1 and 2 are held together by mechanical means such as clamping so that the faying surfaces 3 and 4 are in physical contact with each other before the start and during welding. The head 5 is rotated as shown by arrow 7, plunged downwardly into the work pieces 1 and 3 as shown by arrow 8 and advanced circumferentially as indicated by arrow 9. For a single sided weld, the depth of tool plunge is essentially the thickness of the work pieces or components being welded. For double sided welding such depth can be approximately half the thickness of the work pieces being welded. As a consequence, a circumferential weld is produced.

In the case of repairing a surface-opening crack, for example in a tubular work piece, a similar procedure to that described in connection with FIG. 1 is employed except that the pin 6 is not plunged all the way into the work piece but only superficially and the direction of the advancing tool follows the contour of the crack.

In the practice of the present invention, whether performing FSW or FSP, the process is conducted under conditions sufficient to provide a weld joint or crack repair having a preselected property or set of properties based on the intended use of the weldment. For example, if the use of the weldment requires toughness over fatigue, the conditions are chosen to favor a weld having those properties.

In one embodiment of the present invention, the rotational speed, load and travel speed are chosen to provide the preselected properties of the weld joint or repair.

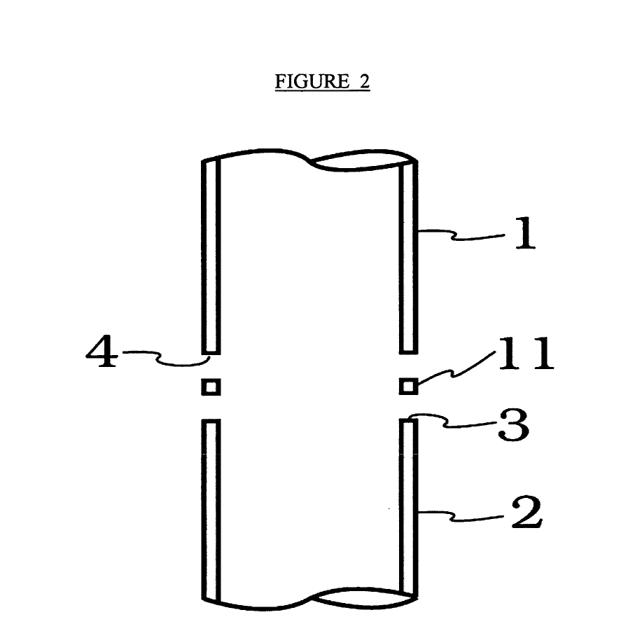

In the exemplary embodiment shown in FIG. 2, the work pieces 1 and 2 have a metal shim 11 interposed between the faying surface 3 and 4. The pieces are arranged so that the faying surfaces are in contact with shim 11. The FSW tool is advanced so as to form a weld incorporating the base metal of work pieces 1 and 2 and metal shim 11. In this embodiment the chemistry of the shim 11 is chosen to provide a weld joint that will meet a preselected property or properties.

In one embodiment of the present invention a data base of weld properties, including but not limited to toughness, strengths, hardness, fatigue, grain size and the like, for various base metals is obtained and correlated to the FSW or FSP conditions under which the weld or repair was performed. Then when a property or set of properties is chosen for weld joint for an intended application, the welding or repair conditions employed will be selected from those conditions that will produce the chosen property or properties.

As will be readily appreciated, the work pieces described in the above embodiments need not be formed of the same base metal. Similarly, the metal shim need not be formed of the same metal as the work pieces. Thus the work pieces may be formed of one material and the shim of a different material, the shim and one work piece may be the same and the other work piece different, or both work pieces and the shim may be different.

In one aspect the present invention is particularly useful in welding high carbon steels, especially those having a CE equal to or greater than 0.48.

### EXAMPLE

API L80 grade steel plates having a CE of 0.94 were joined by FSW under the conditions described below. Normally such high CE value steels would be joined by mechanical connection and not by conventional fusion welding.

Two runs were conducted under the processing parameters given in Table 1 below. In each run a polycrystalline cubic boron nitride tool was used with a single sided, partial penetration on the top of the plates.

TABLE 1
FSW Parameters

| Run | Tool Rotation | Z-Load | Travel Speed |
|---|---|---|---|
| 1 | 450 rpm | 9,000 lb. | 4 ipm |
| 2 | 550 rpm | 7,000 lb. | 4 ipm |

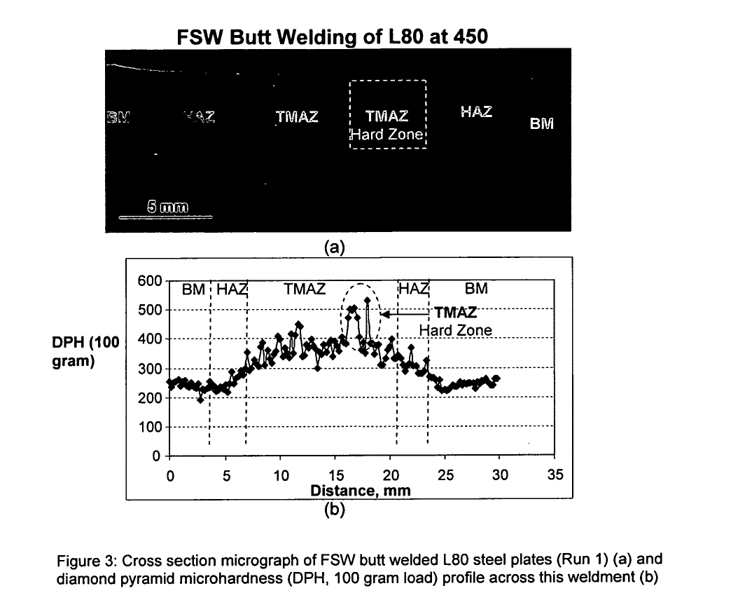

Low magnification optical images of weld cross sections indicating various regions of the samples showed that the weldments were made without any macroscopic defects, FIG. 3. This micrograph also shows the various microstructure regions formed in the FSW weldment.

The average grain size variation in different regions of the weldments is given in Table 2.

TABLE 2
Average Grain Size (μm)

| Run | Base Metal | HAZ | TMAZ | TMAZ-HZ |
|---|---|---|---|---|
| 1 | 20 | 13 | 25 | 30 |
| 2 | 20 | 16 | 30 | 28 |

Microhardness profiles were also obtained for the weldments, an example of such analysis is shown in FIG. 3. The DPH (diamond pyramid hardness) was about 75 DPH lower for the weldment formed at the lower rotational speed (Run 1).

What is claimed is:

1. A method for welding metal parts and repairing cracks in metal parts by subjecting the faying surfaces of the metal parts to be welded to FSW and the cracks to be repaired to FSP under conditions sufficient to provide a weld joint or crack repair having a preselected property or set of properties based on the intended use of the weldment.

2. The method of claim 1 wherein the preselected property or set of properties is selected from toughness, hardness, strength, fatigue, grain size, and residual stress.

3. The method of claim 2 wherein the conditions sufficient to provide the weld joint or crack repair are selected from at least one of the rotational speed, load and travel speed of the FSW tool used to affect the weld or repair.

4. The method of claim 3 wherein the condition sufficient to provide a weld joint having a preselected property or set of properties includes interposing a metal shim of preselected chemistry between the faying surfaces of the metal parts to be welded before subjecting them to FSW.

5. The method of claim 3 wherein the metal parts are ferrous metal parts of the same composition.

6. The method of claim 4 wherein the shim and metal parts are ferrous metal parts of the same composition.

7. The method of claim 3 wherein the ferrous metal has a CE equal to or greater than 0.48.

8. The method of claim 7 wherein the ferrous metal has a CE of about 0.94.

9. A method for welding two pieces of metal to produce a weld joint having a specific property or set of properties chosen for an intended application, the method comprising:
obtaining a data base of weld properties for weld joints formed by FSW under a plurality of conditions and from various metal compositions;
correlating the weld conditions and metal compositions to the weld properties;
selecting weld conditions from the data base that will produce a weld joint having the property or set of properties best suited to the intended application;
subjecting the work pieces to FSW under the conditions selected.

10. The method of claim 9 wherein the metal pieces are ferrous metals having a CE equal to or greater than 0.48.

11. The method of claim 10 wherein the FSW conditions include rotational speed, load and travel speed of the FSW tool used to effect the weld.
